(19) United States
(12) Patent Application Publication
(10) Pub. No.: US 2018/0342348 A1
(43) Pub. Date: Nov. 29, 2018

(54) ARRANGEMENT FOR INDUCTIVELY SUPPLYING ENERGY TO ELECTRIC OR HYBRID VEHICLES

(71) Applicant: Magment UG (Haftungsbeschrankt), Unterhaching (DE)

(72) Inventor: Mauricio Esguerra, Taufkirchen (DE)

(21) Appl. No.: 15/763,661

(22) PCT Filed: Oct. 6, 2016
(86) PCT No.: PCT/EP2016/073930

§ 371 Date: Mar. 27, 2018

(30) Foreign Application Priority Data
Oct. 7, 2015 (DE) 10 2015 012 950.3
Oct. 5, 2016 (DE) 10 2016 118 900.6

(51) Int. Cl. H01F 38/14; B60L 11/18; H01F 1/37; H01F 3/08; H01F 27/28

(52) U.S. Cl. CPC H01F 38/14; B60L 11/182; B60L 11/1829; B60L 2230/10; H01F 1/37; H01F 3/08; H01F 27/2866; B60L 11/1833

(57) ABSTRACT

An arrangement for inductively supplying energy to electric or hybrid vehicles can permit power to be inductively transmitted without contact from a primary coil integrated into a roadway to a second coil located in the vehicle to be supplied. A primary coil can be embedded in a magnetizable concrete so that a magnetic field provided by the primary coil is concentrated toward the intended charging position of the secondary coil located in the vehicle. This can enable power transmission with low stray field and high efficiency.

The invention relates to an arrangement for inductively supplying energy to electric and/or hybrid vehicles by transmitting power from a static primary coil, which is integrated into a surface constructed for driving and provides a magnetic field, to a secondary coil that is located in the vehicle to be powered and matches the provided magnetic field. The invention further relates to the use of such an arrangement and to methods for manufacturing it and for manufacturing a molded body for use in the process.

An arrangement of this type is known from U.S. Pat. No. 5,311,973, for example. In the storage system described therein for electric vehicles, a current flows through a stationary primary coil connected to a power source, which generates a magnetic field that surrounds the primary coil. This magnetic field serves as the medium for the transfer of energy, by means of which a current is induced in a secondary coil, either through relative motion between the primary and secondary coils or by fluctuation of the magnetic field, if the primary coil has alternating current flowing through it. In these types of arrangements, the primary coil is usually stationary in the ground under a roadway, while the secondary coil is located in the electric vehicle to be powered and moves with it. In the arrangement known from EP 0289 868, for example, the magnetic field is generated by modules previously placed in the roadway, and the respective primary coil is entirely buried in a mix of sand and synthetic resin. However, with such types of arrangements the connection to the roadway is susceptible to cracking, and the obtainable efficiency, i.e., the amount of power provided to the secondary coil in proportion to that coming from the primary coil, is generally unsatisfactory.

The goal of the invention is to provide an arrangement by means of which a primary coil can be reliably integrated into a roadway in a simple fashion allowing for manufacturing in any shape and size, while simultaneously allowing for optimal field focusing.

This objective is achieved by an arrangement having the features of claim 1.

Because the primary coil in the invented arrangement is embedded in magnetizable concrete, it is possible to focus the resulting magnetic field so that energy can be transferred to a secondary coil located in a vehicle within the distance range of 5-50 cm between the primary and secondary coils that is required for electric vehicles and with higher efficiency.

With the invented arrangement it is important that the primary coil not be fully surrounded by the magnetizable concrete, but rather its surface area facing the planned charging position of the secondary coil must be free of the magnetizable concrete. One extreme could be a configuration in which the magnetizable concrete is in the form of a flat plate, on which the coil is laid. However, the obtainable focus of the magnetic field in such a case is often not optimal Far better focus can easily be achieved if a trough- or furrow-shaped channel is formed in the magnetizable concrete with its open side facing the charging position of the secondary coil, in which the primary coil is suitably embedded, for example laid or pressed in. This type of channel can have, for example, a U- or V-shaped, semicircular, parabolic, or open-polygon cross-section. They are preferably created by pouring the magnetizable concrete directly into corresponding molds, but they can also be created later by cutting away the magnetizable concrete in the appropriate shapes. In many cases, such as those involving complicated geometries, the desired final form of the molded body planned for a channel can also be achieved by modular construction using appropriately shaped preforms. In most cases it has proven effective to have the depth of the channel match the cross-section of the coil, so that the coil does not extend beyond the upper edge of the channel when placed in it. However, it can also be desirable, and is not excluded from the invention, for the channel to be relatively less deep, so that part of the coil when installed extends beyond the upper edge of the channel. Such embodiments of the invention can vary between those in which the coil extends only slightly beyond the channel to those in which up to about half of it extends beyond the channel. In general, embodiments of the channels are configured that allow for easy installation of the primary coil by laying it or pressing it in. According to a preferred embodiment, the cross-sections of the coil and of the channel match each other, so that the air space or clearance between the coil and the magnetizable concrete can be adjusted as needed. In one possible embodiment, after the primary coil is installed the channel can be filled with a stabilizing fill material, such as sand, before the additional road construction is done to prepare the roadway surface.

The primary coils can be any coils or coil systems used in standard charging systems for electric vehicles that are suitable for embedding in a structure intended for driving such as a cement or asphalt roadway. Such coils are known to professionals in the field and require no additional explanation. Examples include but are not limited to coils with cross-sections that are round, oval, elliptical, or polygonal with three, four, five, or six sides. Coils are normally used to establish a magnetic exchange field, involving frequencies generally in the range of 10-500 kHz, and more particularly 20-100 kHz. The required alternating voltages and currents are supplied in known ways by inverters, which are preferably connected to the primary coils by the shortest possible leads.

According to the invention, the primary coils are embedded in magnetizable concrete with an initial permeability of at least 10, preferably at least 20, and even better at least 30, but resorting to an initial permeability of 100 or more only in special cases, for reasons of functionality. In general, the higher the selected initial permeability, the more stray fields can be avoided. Initial permeability should be understood to mean the permeability that the material demonstrates under the influence of a nearby oscillating magnetic field. It is specified, for example, according to the standard IEC 620 44-2. Initial permeability is significantly influenced by the ratio between grain size and the diameter of the magnetic domain for the respective selected soft magnetic material, wherein the existing domain is considered to be a range with homogeneous magnetic polarization, as occurs in ferromagnets, for example. Experience has shown that high initial permeability is achieved with soft magnetic materials whose grain diameter is relatively large compared to the domain diameter. For example, for ferrites, used by preference as a soft magnetic material, the typical domain diameter falls within the range of about 0.5 μm, while a range of 0.1-10 mm has proven to be suitable for their average grain diameter. The optimal average grain diameter and the optimal grain size distribution corresponding to the respective average grain diameter are determined by measuring the desired permeability in preliminary tests. In this regard, it must be taken into consideration that the magnetic field concentration from the magnetizable concrete needed for sufficient focus ultimately depends on the distance between the embedded primary coil and the secondary coil. The larger that distance, the smaller the lowest permeability of the magnetizable concrete needed for the focus. For a typical ratio of the lateral coil dimension, i.e., the coil width, to the coil distance between primary and secondary coils in the area of about 10, permeability in the range of about 30 is sufficient.

The main components of the magnetizable concrete are one or more soft magnetic materials as well as a binding agent or binding mixture. In the finished soft magnetic concrete, these components are mixed with each other as homogeneously as possible, and if necessary small portions of auxiliary materials can be added to the mix, to improve the mixing or flow characteristics, for example.

Examples of soft magnetic materials contained in the magnetizable concrete include soft ferrites, nanocrystalline metals, amorphous metals, or metal powder. The soft magnetic materials can be added individually or as a mixture. For reasons of simplicity, the following makes reference respectively to only one soft magnetic material; however, the information applies equally to mixes of multiple soft magnetic materials. The use of ferrites has the advantage that ferrite materials like those generated as scrap from the high-tech manufacture of conventional components made of ferrite or from recycling electromagnetic devices can also be used.

The portion by weight of the respective selected soft magnetic materials is preferably at least 80 weight-percent, and even better 85-95 weight-percent. This proportion has proven effective in particular when using soft ferrites, because it allows good magnetizability of the concrete as well as good formability and mechanical stability. In principle, however, in many cases portions by weight of the soft magnetic material between a lower limit of about 60 weight-percent and an upper limit of about 98 weight-percent are not excluded. The portions by weight appropriate for the respective application are determined by means of preliminary tests. In general, for cost-related reasons, the upper limit for the value at which magnetic saturation occurs will not be exceeded, and the lower limit is considered to be that at which adequate magnetization is possible.

In most cases, the goal is the highest possible content of soft magnetic material in the magnetizable concrete. This is preferably achieved, for example, by selecting soft magnetic materials with certain grain size distributions, so as to obtain the densest possible compression of the material particles. A soft magnetic material, such as soft magnetic ferrite, in two or more grain size fractions has proven to be optimal In particular, a first fraction having an average grain diameter of 2-10 mm and a grain size distribution of 0.5-20 mm can be combined with a second fraction having an average grain diameter of 0.1-0.5 mm and a grain size distribution of 0.01-5 mm. Such fractions are usually included in nearly equal proportions by weight, with deviations of up to about 20 weight-percent above or below being acceptable. Such combinations of different fractions of soft magnetic ferrite are known from EP 1 097 463, for example, and according to that document can be embedded in a formed and hardened hydraulic cement matrix, among other things, when manufacturing magnetizable products. In that case, the respective magnetizable product contains the soft magnetic material at a proportion by weight of more than 80 percent. In the aforementioned document, the formable mass is described as being also especially well suited, among other applications, for covering an electrical element such as a coil for shielding purposes.

A particular advantage of the invented arrangement is that the binding agent or binder mix contained in the magnetizable concrete can be selected from among materials that are compatible with those used for the roadway construction. The binder can therefore be, for example, a material routinely used in road construction such as hydraulic cement, e.g., white cement or Portland cement, or asphalt, e.g., paving asphalt, natural bitumen, or polymer-modified asphalt types. Although the use of binder mixes as well is not in principle excluded in most cases, it has generally proven effective to use just one particular binding substance. For example, white cement is preferable when it is desired that the magnetizable concrete have exceptional compression resistance. It is also advantageous to adapt the thermal expansion and softening characteristics of the magnetizable concrete to those of the respective roadway structure, such as a cement road or asphalt road, by selecting the appropriate binding substance. This ensures durable and robust binding between the roadway structure and the primary coil integrated into it. In particular, it can also ensure that a primary coil with the magnetizable concrete surrounding it can be integrated durably and without cracking into an already existing street or highway. In selecting a binder substance, it should also be taken into consideration that many substances which are well-suited in principle, such as coal tar, can be used only sparingly or not at all due to legal stipulations.

In addition to the soft magnetic material and the binding agent or binding mixture, the magnetizable concrete can also contain other auxiliary materials such as superplasticizers, fillers, gypsum, and similar substances in order to control characteristics like flow behavior, pouring ability, hardening, and/or curing.

For manufacturing an arrangement according to the invention, the magnetizable concrete is preferably prepared as the most homogeneous and pourable possible mix of the primary components and any auxiliary materials that may be needed. Standard mixing methods are suitable for this, as are known to road construction professionals, for example. Therefore, for magnetizable concrete in which the use of a cement-based binding substance is planned, water as well as a thinner if needed would generally be added during the mixing process. A standard concrete mixer can be used for mixing. For magnetizable concrete in which the use of an asphalt-based binding substance is planned, a heat mixer that provides the mixing and processing temperature needed to guarantee the pouring ability of the mix can be used in the standard manner for the mixing process. In principle, the mixing process can be performed in such a way that the soft magnetic material is added first and then mixed with the binding substance. It is also possible to start with the binding substance first and then add the soft magnetic material into it. In many cases, however, the components are added together and mixed little by little in the subsequent mixing process. If soft magnetic material with different grain size fractions is used, it can also be advantageous to first create separate mixtures of each grain size fraction with the binding substance and then combine these mixtures and further homogenize them as necessary.

The pourable magnetizable concrete mixture prepared in such a way is then shaped into the form suited to hold the primary coil in a subsequent step. According to one advantageous embodiment, a premade form for this purpose is placed underground below the roadway structure. The prepared mixture is poured into it and tamped down as needed, so that once the mixture is set, generally by curing or cooling, the resulting molded body has a channel suitable for appropriately holding the respective intended primary coil and, if necessary, its wiring. However, experience has shown that, if the above-described magnetizable concrete has good flow characteristics, in most cases additional tamping is not needed.

Next, the primary coil is laid or pressed, for example, into this channel. Next, preferably, after the mold is removed, the planned electrical power cables for the primary coil are put in place and connected to it. However, it is also possible for the electrical power cables to be put in place before that in a prior step, so that they only need to be connected to the primary coil after the mold is removed.

Then, finally, the roadway structure can be finished, for example by applying an asphalt- or cement-based top layer according to standard road construction practices.

In principle, the molded body with the channels intended to hold the primary coil can also be made in a separate location other than that where it will be used and then brought to its planned position, such as a suitable channel in the roadway structure. In addition to the aforementioned pouring, the channels in the molded body can also be made by a cutting process, e.g., milling, cutting, or grinding, or in a building process by assembling correspondingly formed components or modules into the desired shape.

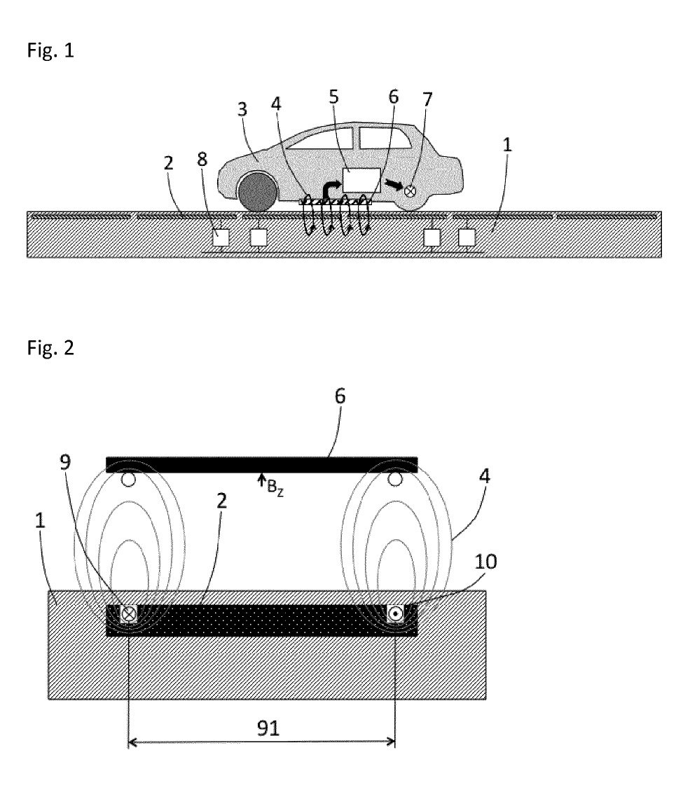

The invention is further explained below with reference to FIGS. 1-3.

FIG. 1 schematically shows a transfer area in cross-section, as it would be configured for dynamic or even static inductive charging of electric vehicles.

FIG. 2 schematically shows an arrangement according to the invention in cross-section with a primary coil embedded in magnetizable concrete and integrated into a roadway structure.

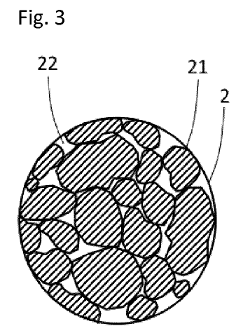

FIG. 3 schematically shows the composition of a magnetizable concrete suitable for embedding a primary coil according to the invention.

FIG. 1 shows a roadway structure 1 into which primary coils embedded in magnetizable concrete 2 and arranged in rows next to each other are integrated. The field lines 4 schematically show that the primary coils generate a magnetic field that is focused by the magnetizable concrete. When a vehicle 3 with a secondary coil 6 located in it comes into the area of the magnetic field, which is configured as an alternating field, for example, alternating voltage that can be used by the vehicle as the power supply is induced in the secondary coil. For example, the induced alternating voltage can be rectified and limited for storage in batteries. According to the embodiment shown, the transferred electrical energy can be also be sent directly to the drive 7 by means of a suitable control module 5. The alternating voltage needed to supply the primary coil with the current required for the energy transfer is generated by inverters 8, which preferably are connected by short cables to the primary coil embedded in the magnetizable concrete 2.

FIG. 2 shows the primary coil 9 with a coil width 91 embedded in the magnetizable concrete 2, which is in turn placed into the roadway structure 1. The molded body, made of magnetizable concrete, has trough-shaped channels 10 with open tops in position to charge the secondary coil 6, in which the primary coils 9 are located. When a current flows through these primary coils, a magnetic field is generated, whose field lines 4, as schematically shown, are focused through the effect of the magnetizable concrete 2 in the direction of the planned charging position of an electric vehicle as it drives through a charging area for dynamic or static inductive charging. This brings the secondary coil 6 of the electric vehicle into the effective range of the magnetic field, and voltage is induced. By appropriately focusing the magnetic field, the power transferred to the secondary coil can be at least 80% of the power generated at the primary coil, even at a distance from the primary coil equal to many times the coil width 91. It appears that arrangements are even possible in which at least 80% of the power generated at the primary coil can be transferred to the secondary coil at a distance from the primary coil equal to ten times the coil width.

FIG. 3 schematically shows, in cross-section, the structure of a magnetizable concrete 2 that can be used in the arrangement according to the invention. It comprises many soft magnetic particles 21, consisting of soft ferrite, for example, which are incorporated into the matrix 22 of a binding substance, consisting of Portland cement, for example. This allows the particles 21 to come into contact with each other while also being separated from each other by the binding substance. As appropriate, particles of auxiliary substances such as quartz, calcined alumina, gypsum, or the like can also be used to make the magnetizable concrete compatible with the roadway structure.

In one embodiment of the invention, in a first version of the process, magnetizable concrete for integration into a Portland cement-based roadway structure is first mixed using standard concrete technology. In this case, the soft magnetic material used is a mixture of about 50 mass-% soft magnetic ferrite having a granulometric composition with an average grain diameter of about 5 mm, and about 40 mass-% soft magnetic ferrite having a granulometric composition with an average grain diameter of about 0.25 mm (respective average grain diameters determined by sieve analysis). The binding substance is a mixture of about 5 mass-% Portland cement, about 0.5 mass-% of a standard thinner, and about 4.5 mass-% water. The soft magnetic material and binding substance are mixed in a standard mixer until a homogeneous pourable mass is formed. Testing this mixture after hardening shows an initial permeability of 35, measured on a toroidal core.

The resulting mixture is poured into a prepared mold placed in the ground under a roadway structure, wherein the mold is located such that the poured mass forms a channel, open at the top in the planned charging position for the secondary coil, intended to hold a primary coil. After the concrete hardens, the casting mold is removed, the primary coil with a coil width of 80 cm is embedded in the channel, and electrical cables are connected to its front and end. Finally, a cover layer of Portland cement is applied according to standard practices.

In a second version of the process, magnetizable concrete suitable for integration into an asphalt-based roadway structure is mixed, using a heat mixer operating at a temperature of about 210° C. to create the mixture. The soft magnetic material used is again a mixture of about 50 mass-% soft magnetic ferrite having a granulometric composition with an average grain diameter of about 5 mm, and about 40 mass-% soft magnetic ferrite having a granulometric composition with an average grain diameter of about 0.25 mm (respective average grain diameters determined by sieve analysis). The binding substance used is about 10 mass-% of an asphalt compatible with the planned roadway structure. The soft magnetic material and binding substance are mixed in the heat mixer until a homogeneous pourable mixture is formed. Testing the resulting mixture shows an initial permeability comparable to that in the first version of the process, with a value of about 35, also measured on a toroidal core.

Like the first version of the process, the resulting mixture is poured and pressed into a prepared mold placed in the ground under a roadway structure, so that after it cools it is suitably shaped to hold a primary coil. Next, the casting mold is removed, the primary coil with a coil width of 80 cm is embedded in the channel, which is open at the top in the planned position for charging the secondary coil, and electrical cables are connected to its front and end. Finally, a cover layer of asphalt is applied according to standard practices.

Having the composition of the magnetizable concrete adapted in such a way to the roadway structure, according to the first and second versions of the process, prevents differing thermal expansions of the roadway structure and the magnetizable concrete that could lead to mechanical fatigue and increased wear with the resulting loss of function. It also means that the functional reliability of the primary coil's alternating voltage supply is not impeded due to temperature change.

In order to generate the required magnetic field, the primary coils are connected to inverters that generate alternating voltages with the currents required for the energy transfer. For the alternating magnetic field, frequencies in the range of 10-500 kHz are used. With a magnetizable concrete permeability of μᵢ=40, for a distance of 25 cm to a secondary coil, an energy transfer efficiency of 95% could be achieved because of the magnetic field focusing that results from embedding the primary coil in the magnetizable concrete.

In addition to the high efficiency of non-contact inductive energy transfer, the invented arrangement is also distinguished in that it permits the magnetic field to be concentrated, which allows it to comply with the previously described magnetic field limits in and around electric and/or hybrid vehicles during the charging process. The magnetic field concentration according to the invention can be used advantageously for the static, stationary, or dynamic charging of batteries or accumulator cells in electric and/or hybrid vehicles. It is similarly suitable for directly supplying electric and/or hybrid vehicles with energy, e.g., drive energy. The invented arrangement can be used, for example, for maimed or unmanned street or rail vehicles. It also allows primary coils to be installed over longer stretches of roadway structure with the resulting dynamic inductive charging while driving. The invented arrangement can be used advantageously with asphalt- or concrete-based roadway structures due to the compatibility of the materials. It is equally suitable for asphalt or cement streets and also for cement or asphalt surfaces inside or outside of buildings, such as for non-contact inductive charging or powering of conveyor vehicles in factory or warehouse spaces, for example. An additional advantageous application area is rail transport conveyances that travel over rail sections that are integrated into an asphalt or cement structure, such as streetcars that operate without overhead wires.

1. An arrangement for inductively supplying energy to a vehicle, the vehicle being an electric vehicle and/or a hybrid vehicle, the arrangement comprising:
a primary coil integrated into a surface constructed for driving, the primary coil configured to provide a magnetic field to a secondary coil located in the vehicle;
the primary coil being embedded in magnetizable concrete with an initial permeability of at least 10 such that the magnetic field generated by the primary coil is focused upward toward a charging position of the secondary coil located in the vehicle.

2. The arrangement of claim 1 wherein a trough-shaped channel or furrow-shaped channel is formed in the magnetizable concrete with its open side facing the charging position of the secondary coil, the primary coil embedded within the channel.

3. The arrangement of claim 2 wherein the magnetizable concrete contains particles of at least one soft magnetic material comprising at least one of: soft ferrites, nanocrystalline metals, amorphous metals, and metal powder, and the magnetizable concrete particles are incorporated into a matrix of a binding substance that is usable with concretes.

4. The arrangement of claim 3 wherein the binding substance is comprised of hardened hydraulic cement, white cement, Portland cement, or asphalt.

5. The arrangement of claim 4 wherein the soft magnetic material in the magnetizable concrete is at least 80 weight-percent magnetic ferrite material.

6. The arrangement of claim 5 wherein the at least one soft magnetic material consists of a mixture of soft magnetic ferrite with an average grain diameter of 2-10 mm and soft magnetic ferrite with an average grain diameter of 0.1-0.5 mm.

7. The arrangement of claim 6 wherein the roadway structure is an asphalt street, a cement street, a cement or asphalt surface inside or outside of a building, or a section of rails integrated into an asphalt or cement structure.

8. The arrangement of claim 1 wherein that the thermal expansion and softening behaviors of the magnetizable concrete are adapted to those of the roadway structure.

9. The arrangement of claim 1, wherein the arrangement is configured for at least one of: static, stationary or dynamic charging of batteries in electric and/or hybrid vehicles, and directly powering electric and/or hybrid vehicles.

10. A method for manufacturing an arrangement for inductively supplying energy to a vehicle comprising:
preparing a pourable mixture of a magnetizable concrete that has an initial permeability of at least 10,
pouring the magnetizable concrete into a prepared mold placed under a roadway structure or in a separate location, in such a way that after the magnetizable concrete hardens it forms a molded body with a trough-shaped channel or furrow-shaped channel suitable for holding a primary coil
placing the primary coil into the specifically trough-shaped channel or furrow-shaped channel in the molded body,
placing the molded body in a channel in a roadway structure,
connecting the primary coil to electrical power supply cables,
finishing the roadway structure.

11. A method for manufacturing a molded body comprising:
preparing a pourable mixture of a magnetizable concrete that has an initial permeability of at least 10,
pouring the magnetizable concrete into a prepared mold, placed under a roadway structure or in a separate location, in such a way that after the concrete hardens it forms a molded body with a specifically trough-shaped channel or furrow-shaped channel suitable for holding a primary coil or facilitating formation of the primary coil in the channel by subsequent cutting or shaping processes.

12. (canceled)

13. A molded body comprising:
a magnetizable concrete having an initial permeability of at least 10, the concrete having a channel defined therein that is configured to hold a primary coil or facilitate formation of a primary coil in the channel by subsequent cutting or shaping processes, the primary coil configured to generate a magnetic field such that the magnetic field generated by the primary coil is focused upward toward a charging position of a secondary coil located in a vehicle.

14. The method of claim 10, wherein the placing of the primary coil into the specifically trough-shaped channel or furrow-shaped channel in the molded body comprises cutting or shaping the concrete adjacent the channel to define the primary coil within the channel.

15. The arrangement of claim 4 wherein the primary coil is a static primary coil.

16. The arrangement of claim 1 wherein the initial permeability of at least 20 or at least 30.

17. The arrangement of claim 1 wherein the vehicle is a car.

18. The arrangement of claim 1 wherein the vehicle is a train.

19. The arrangement of claim 1 wherein the concrete is comprised of a mixture of soft magnetic ferrite with an average grain diameter of 2-10 mm and soft magnetic ferrite with an average grain diameter of 0.1-0.5 mm, the mixture being at least 80 weight percent of the concrete.

20. The arrangement of claim 1, wherein the magnetic field has a frequency between 10 kHz and 500 kHz.
